(19) United States
(12) Patent Application Publication
(10) Pub. No.: US 2016/0101749 A1
(43) Pub. Date: Apr. 14, 2016

(54) METHOD AND SYSTEM OF AUTO-ADJUSTING VEHICLE SETTINGS

(71) Applicant: CHIUN MAI COMMUNICATION SYSTEMS, INC., New Taipei (TW)

(72) Inventors: CHING-YUAN WU, New Taipei (TW); WEI-PENG KAO, New Taipei (TW)

(21) Appl. No.: 14/686,361

(22) Filed: Apr. 14, 2015

(30) Foreign Application Priority Data
Oct. 9, 2014 (CN) 201410529412.4

(51) Int. Cl. B60R 16/037; B60R 25/00

(52) U.S. Cl. CPC B60R 16/037; B60R 25/00; B60R 2325/103

(57) ABSTRACT

Provided is a method of auto-adjusting the settings of a vehicle. The vehicle includes a first NFC device. The method includes: determining whether an electrical device is an authorized device through the first NFC device communicating with a second NFC device of the electrical device, the electrical device storing an identification information; obtaining a user's preference settings to the vehicle according to the identification information from the electrical device upon a condition that the electrical device is the authorized device; and adjusting the settings of the vehicle with the user's preference settings.

### FIELD

The subject matter herein generally relates to vehicle's automated technologies, and particularly to a method and a system of auto-adjusting vehicle settings.

### BACKGROUND

If several users use a common vehicle, each user needs to manually adjust the settings of the vehicle before driving the vehicle, for example, adjusting positions of seats, angles of rear view mirrors, etc.

### BRIEF DESCRIPTION OF THE DRAWINGS

Implementations of the present technology will now be described, by way of example only, with reference to the attached figures, wherein:

FIG. 1 is a working environment of a system of auto-adjusting vehicle settings according to an embodiment of the instant disclosure.

FIG. 2 is a block diagram of the system of auto-adjusting vehicle settings of FIG. 1.

FIG. 3 is a flowchart illustrating a method of auto-adjusting vehicle settings according to an embodiment of the instant disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series and the like.

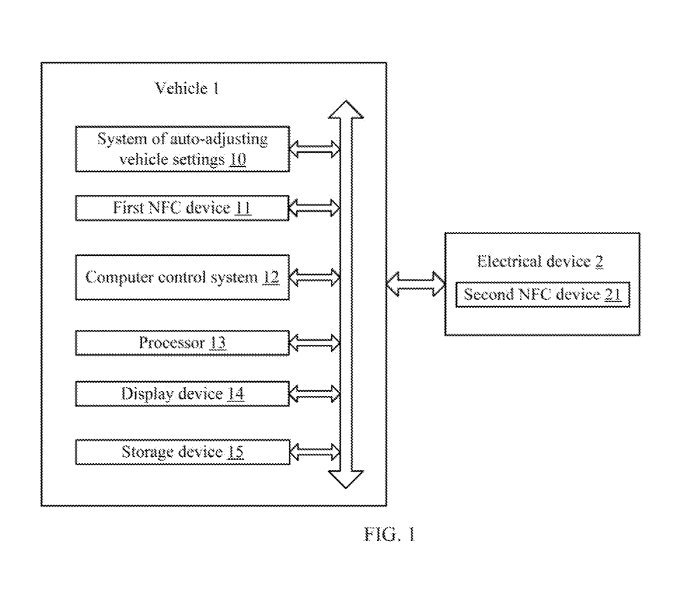

Referring to FIG. 1, a working environment for a system 10 of auto-adjusting vehicle settings is shown. The system 10 run in a vehicle 1. The vehicle 1 includes a first Near Field Communication (NFC) device 11 mounted on the vehicle 1 the vehicle 1. The first NFC device 11 communicates with an electrical device 2. The electrical device 2 includes a second NFC device 21 configured to communicate with the first NFC device 11.

The vehicle 1 includes a computer control system 12. The computer control system 12 can obtain all kinds of settings of the vehicle 1 via sensors of the vehicle 1. The computer control system 12 can also control and adjust the settings of the vehicle 1, for example, positions of seats, angles of rear view mirrors, temperature of air conditioner, etc. In at least one embodiment, the system 10 is independent from the computer control system 12 and however in communication with the computer control system 12. In other embodiments, the system 10 can be embedded in the computer control system 12.

The vehicle 1 also includes, but not limited to, a processor 13, a display device 14 and a storage device 15. The storage device 15 can be a RAM. The storage device 15 can also be a smart media card, a secure digital card, a flash card, or other external storage devices. The software program instructions or data of the system 10 and the computer control system 12 are stored in the storage device 15 and are executed by the processor 13.

The storage device 15 stores identification information of all authorized electrical devices and user's preference settings of the all authorized electrical devices, for example, the positions of the seats, the angles of the rear view mirrors, the temperature of the air conditioner, etc. The electrical device 2 stores identification information. The system 10 obtains the identification information of the electrical device 2 via the first NFC device 11 and the second NFC device 21 and determines whether the identification information of the electrical device 2 matches the identification information stored in the storage device 15, so as to determine whether the electrical device 2 is an authorized device. If the electrical device 2 is an authorized device, the system 10 receives the user's preference settings from the authorized electrical device 2 and adjusts all kinds of settings of the vehicle 1 according to the user's preference settings from the authorized electrical device 2.

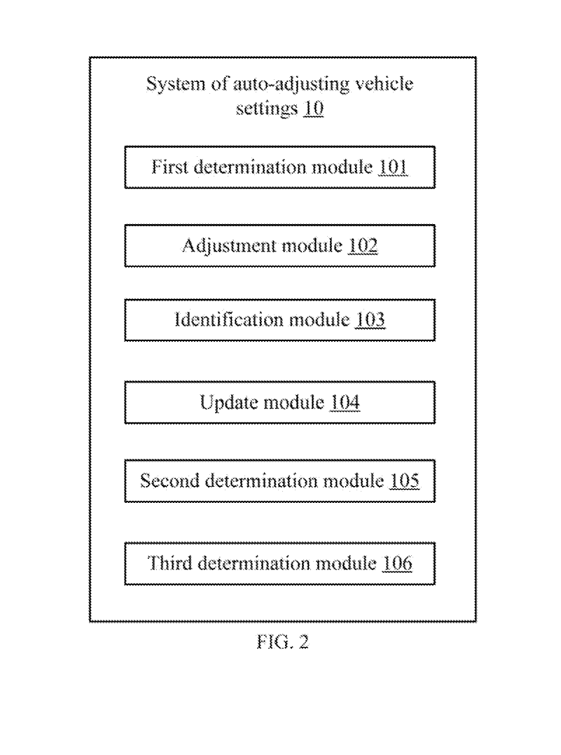

Referring to FIG. 2, an embodiment of the system 10 includes a first determination module 101, an adjustment module 102, an identification module 103, an update module 104, a second determination module 105, and a third determination module 106. The word “module,” as used hereinafter, refers to a collection of software instructions which are stored in storage device 15 and can be executed by the processor 13.

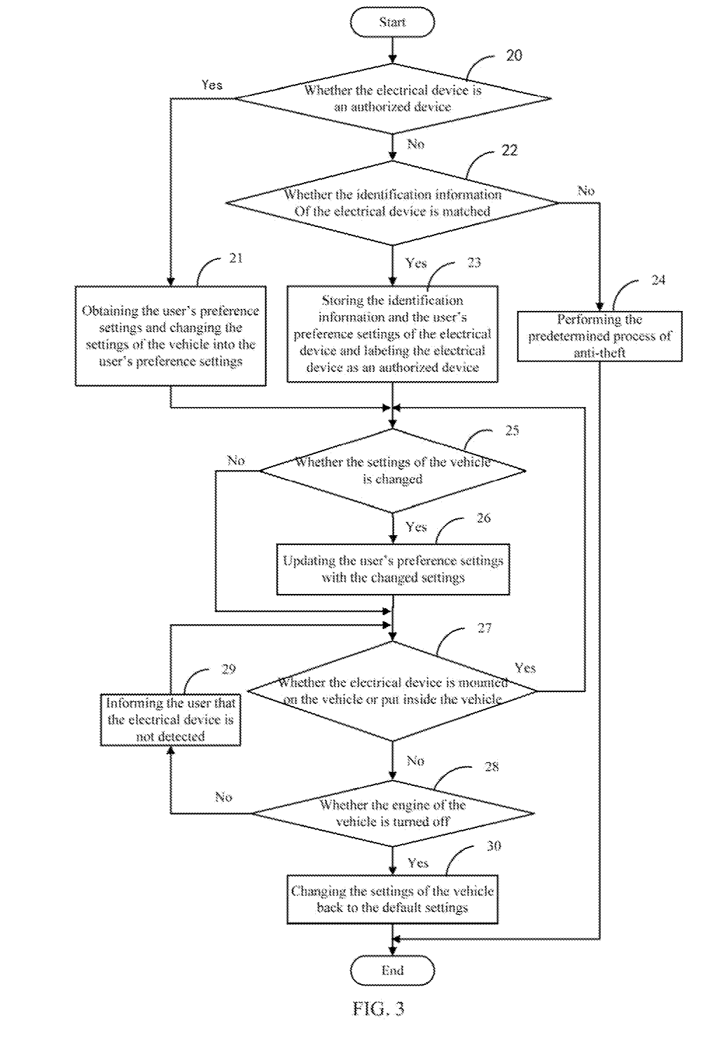

Referring to FIG. 3, a flowchart is presented in accordance with an example embodiment. An example method is provided by way of example, as there are a variety of ways to carry out the method. The example method described below can be carried out using the configurations illustrated in FIG. 3, for example, and various elements of these figures are referenced in explaining example method. Each block shown in FIG. 3 represents one or more processes, methods or subroutines, carried out in the example method. Furthermore, the illustrated order of blocks is illustrative only and the order of the blocks can change according to the present disclosure. Additional blocks can be added or fewer blocks may be utilized, without departing from this disclosure. The example method can begin at block 20.

At block 20, when the electrical device 2 is mounted on the vehicle 1 or put inside the vehicle 1, the first determination module 101 determines whether the electrical device 2 is an authorized device. If the electrical device 2 is an authorized device, block 21 is performed. If the electrical device 2 is not an authorized device, block 22 is performed. In the illustrated embodiment, the first determination module 101 obtains the identification information of the electrical device 2 through the first NFC device 11 and the second NFC device 21 and determines whether the identification information of the electrical device 2 matches the identification information stored in the storage device 15, so as to determine whether the electrical device 2 is an authorized device.

At block 21, the adjustment module 102 changes the settings of the vehicle 1 into the user's preference settings of the electrical device 2 according to the obtained identification information from the electrical device 2. In the illustrated embodiment, the adjustment module 102 adjusts the settings of the vehicle 1 according to the user's preference settings stored in the storage device 2 through the computer control system 12. In other embodiments, if the user's preference settings are stored in the electrical device 2, the adjustment module 102 obtains the user's preference settings from the electrical device 2 through the first NFC device 11 and the second NFC device 21 and adjusts the settings of the vehicle 1 according to the user's preference settings from the electrical device 2.

At block 22, the identification module 103 identifies the user's identification of the electrical device 2 and determines whether the electrical device 2 is identified. If the electrical device 2 is identified, block 23 is performed. If the electrical device 2 is not identified, block 24 is performed. In the illustrated embodiment, the identification module 103 triggers a window in the display device 14 for the user to input password, and determines whether the electrical device 2 is identified according to the password input by the user. In other embodiments, the identification module 103 can determine whether the electrical device 2 is identified through other means, for example, fingerprint identification, sound identification, etc.

At block 23, the identification module 103 labels the electrical device 2 as an authorized device and stores the user's preference settings and the identification information obtained from the electrical device 2 into the storage device 15.

At block 24, the identification module 103 performs a predetermined process of anti-theft. In the illustrated embodiment, the predetermined process of anti-theft refers to generating an alarm sound. In other embodiment, the predetermined process of anti-theft can refer to locking doors of the vehicle 1, or turning the engine of the vehicle 1 off.

At block 25, the update module 104 determines whether the settings of the vehicle 1 is changed. If the settings of the vehicle 1 is changed, block 26 is performed. If the settings of the vehicle 1 is not changed, block 27 is performed. In the illustrated embodiment, the updated module 104 obtains the current settings of the vehicle 1 through the computer control system 12, and compares the current setting of the vehicle 1 with the user's preference settings, so as to determine whether the settings of the vehicle 1 is changed. In other embodiment, the update module 104 can also determine whether the settings of the vehicle 1 is changed through other ways, for example, the settings of the vehicle 1 at two different time points are compared with each other to determine whether the settings of the vehicle 1 is changed.

At block 26, the update module 104 stores the changed settings into the storage device 15 and updates the user's preference settings with the changed settings. In other embodiments, if the user's preference settings are stored in the electrical device 2, the update module 104 stores the changed settings into the electrical device 2 as the user's preference settings.

At block 27, the second determination module 105 determines whether the electrical device 2 is mounted on the vehicle 1 or put inside the vehicle 1. If the electrical device 2 is mounted on the vehicle 1 or put inside the vehicle 1, block 25 is performed; otherwise, block 28 is performed. In the illustrated embodiment, the second determination module 105 determines whether the identification information of the electrical device 2 can be obtained from the second NFC device 21, to determine whether the electrical device 2 is mounted on the vehicle 1 or put inside the vehicle 1.

At block 28, the third determination module 106 determines whether the engine of the vehicle 1 is turned off. If the engine of the vehicle 1 is not turned off, block 29 is performed. If the engine of the vehicle 1 is turned off, block 30 is performed and it is determined that the user left the vehicle 1. In the illustrated embodiment, the third determination module 106 obtains the state of the engine of the vehicle 1 through the computer control system 12, so as to determine whether the engine of the vehicle 1 is turned off.

At block 29, the third determination module 106 informs the user that the electrical device 2 is not detected and block 27 is performed. In the illustrated embodiment, the third determination module 106 triggers a warning window in the display device 15, so as to remind the user that the electrical device 2 is not detected. In other embodiment, other ways can be used to remind the user, for example, playing an audio file.

At block 30, the third determination module 106 changes the settings of the vehicle 1 back to default settings. In the illustrated embodiment, the default settings are stored in the storage device 15 of the vehicle 1. In at least one embodiment, the user can set the default settings.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method of auto-adjusting settings of a vehicle, the method comprising:
determining whether an electrical device is an authorized device, the electrical device storing identification information;
if the electrical device is an authorized device;
obtaining, from the electrical device, a user's preference settings of the vehicle according to the identification information; and
adjusting the settings of the vehicle according to the user's preference settings.

2. The method of claim 1, wherein the user's preference settings is obtained from the electrical device.

3. The method of claim 1, wherein the user's preference settings is obtained from the vehicle.

4. The method of claim 1, wherein the vehicle stores identification information of all authorized devices, the electrical device is determined to be the authorized device when the identification information from the electrical device matches the identification information stored in the vehicle.

5. The method of claim 1, comprising:
identifying the electrical device upon a condition that the electrical device is not the authorized device.

6. The method of claim 5, comprising:
storing the identification information of the electrical device in the vehicle and labeling the electrical device as the authorized device upon a condition that the electrical device is identified.

7. The method of claim 5, comprising:
performing a predetermined process of anti-theft upon a condition that the electrical device is not identified.

8. The method of claim 1, wherein after adjusting the settings of the vehicle with the user's preference settings, the method comprises:
determining whether the current settings of the vehicle are changed; and
updating the user's preference settings with the changed settings upon a condition that the current settings of the vehicle are changed.

9. A vehicle comprising:
a first NFC device;
a processor;
a display device;
a storage device; and
one or more programs that are stored in the storage device and are executed by the processor, the one or more programs comprising:
a first determination module that determines whether an electrical device is an authorized device, the electrical device storing an identification information; and
an adjustment module that obtains the identification information from the electrical device through the first NFC device and a second NFC device of the electrical device and changes the settings of the vehicle into a user's preference settings according to the identification information from the electrical device.

10. The vehicle of claim 9, wherein the one or more programs comprise an identification module that identifies the electrical device.

11. The vehicle of claim 10, wherein the identification module labels the electrical device as the authorized device and stores the identification information of the electrical device into the storage device when the electrical device is identified by the identification module.

12. The vehicle of claim 10, wherein the identification module performs a predetermined process of anti-theft when the electrical device fails to be identified by the identification module.

13. The vehicle of claim 9, wherein the one or more programs comprise an update module that determines whether the current settings of the vehicle is changed and updates the user's preference settings with the changed settings.

14. The vehicle of claim 9, wherein the one or more programs comprise:
a second determination module that determines whether the electrical device is mounted on or put inside the vehicle; and
a third determination module that determines whether the engine of the vehicle is turned off when the electrical device is not detected by the second determination module.

15. The vehicle of claim 14, wherein the third determination module changes the settings of the vehicle back to default settings when the engine of the vehicle is detected to be turned off.

16. The vehicle of claim 14, wherein the third determination module informs the user that the electrical device is not detected when the engine of the vehicle is detected not to be turned off.
